(19) United States
(12) Patent Application Publication
(10) Pub. No.: US 2003/0055920 A1
(43) Pub. Date: Mar. 20, 2003

(54) Method and apparatus for automatic quality of service configuration based on traffic flow and other network parameters

(76) Inventors: Deepak Kakadia, Union City, CA (US); Preeti Bhoj, Cupertino, CA (US); Ravi Rastogi, Fremont, CA (US); Narendra Dhara, San Jose, CA (US); Vairamuthu Karuppiah, Fremont, CA (US); Ivan Giron, San Jose, CA (US)

Correspondence Address: Joseph K. Hollinger, SKJERVEN MORRILL MacPHERSON LLP, Suite 2800, 3 Embarcadero Center, San Francisco, CA, 94111, US

(21) Appl. No.: 09/956,299

(22) Filed: Sep. 17, 2001

(51) Int. Cl. G06F 15/177

(52) U.S. Cl. 709/220; 709/224

(57) ABSTRACT

A system for automatic quality of service (QoS) configuration within packet switching networks is provided. The system is used in combination compatible network devices that support a QoS interface. The QoS interface allows the device to be dynamically configured to apply different QoS configurations to individual microflows. The QoS interface also allows QoS related events to be monitored. The automatic QoS configuration system allows QoS configurations to be defined in terms of QoS policies. Each QoS policy is a mapping that defines how the QoS configuration for a microflow changes in response to physical, logical or temporal events. A management system controls (at least partially) one or more of the compatible network devices. The management system monitors the QoS events generated by each compatible network device. In response to these and other events, the management system dynamically reconfigures each compatible network device to enforce the QoS policies for that device. The automatic QoS configuration system also includes a management interface. The management interface allows QoS policies to be interactively defined for the compatible network devices.

### TECHNICAL FIELD OF THE INVENTION

The present invention is generally related to communications networks. More specifically, the present invention includes a method and apparatus for automatic configuration for quality of service based on traffic flow and other network parameters.

### BACKGROUND OF THE INVENTION

Communications networks may be broadly classified into circuit switching and packet switching types. Circuit switching networks operate by establishing dedicated channels to connect each sender and receiver. The dedicated channel between a sender and receiver exists for the entire time that the sender and receiver communicate. Packet switching networks require senders to split their messages into packets. The network forwards packets from senders to receivers where they are reassembled into messages. Direct connections between senders and receivers do not exist in packet switching networks. As a result, the packets in a single message may diverge and travel different routes before reaching the receiver.

Managing traffic flow is an important consideration in packet switching networks. Networks of this type are typically expected to transport large numbers of simultaneous messages. These messages tend to be a mixture of different types, each having its own requirements for priority and reliability.

To accommodate the needs of different message types, packet switching networks typically offer differentiated services Differentiated services are analogous, in a very general sense, to the different postage classes offered by most postal services. Within packet switching networks, differentiated services typically allow users to select the type of service that they receive. Typically, this selection in defined at the microflow level. A microflow is a single instance of an application-to-application flow of packets having a source address, a source port, a destination address, a destination port and a protocol id. Each microflow has an associated Quality of Service, or QoS. The QoS for a microflow is defined by a range of parameters such as Peak Information Rate (PIR), Committed Information Rate (CIR), Committed Burst Size (CBS), Exceeded Burst Rate (EBS) as well as a range of scheduling, queuing and policing schemes.

Users can select different microflow and QoS combinations for different types of message traffic. This helps ensure that each type of traffic is handled appropriately. It also allows users to reduce costs by choosing less expensive microflow and QoS combinations for lower priority message traffic.

Unfortunately, the real traffic encountered within packet switching networks is often at odds with the particular services selected by the users. To support particular services selected by users all the network devices in the path should have consistent policy definition that indicates the service treatment. This is generally not the case, there by leading to inconsistency in QoS delivery to user traffic. It can also happen that user needs may suddenly increase overloading the services they have purchased leading to delays and service degradation.

In some cases, it is possible to manually reconfigure the services allocated to users. This becomes difficult, and in some cases, impossible, where large numbers of users are involved. This can be the case, for example, with massively parallel IP services and aggregation switches.

For these and other reasons a need exists for systems to control QoS configurations in packet switching networks. This is particularly true for networks where networks are expected to process a wide range of different message types and handle large numbers of users.

### SUMMARY OF THE INVENTION

The present invention relates to a system (including both method and apparatus) for automatic quality of service (QoS) configuration within packet switching networks. The system is used in combination with one or more compatible network devices.

To be compatible, a network device must support a QoS interface. The QoS interface allows the device to be dynamically configured to apply different QoS configurations to individual microflows. The QoS interface also allows QoS related events for each microflow to be monitored.

The automatic QoS configuration system allows QoS configurations (that define the services allocated to users) to be defined in terms of QoS policies. Each QoS policy is a mapping that defines how the QoS configuration for a microflow changes in response to physical, logical or temporal events.

The automatic QoS configuration system includes a management system. The management system controls (at least partially) one or more of the compatible network devices. The management system monitors the QoS events generated by each compatible network device. Each QoS event involves one or more microflows. In response to these and other events, the management system dynamically reconfigures each compatible network device to enforce the QoS policies for the involved microflows for that device.

The management system includes a policy system, which makes decision on QoS configuration to be enforced at any given time. Policy system includes a management server (policy server) and a policy enforcement point. The primary distinction between the invention proposed here and the policy systems that exist today is that typically the policy enforcement point resides within a device being managed by policy system. With the proposed invention the policy enforcement point is a logical component capable of enforcing policies and QoS configuration on a large number of physical and logical devices. This becomes particularly important for large IP services and aggregation switches where each physical device is a collection of a large number of logical devices.

Another important distinction is the definition and enforcement of policies on a per customer basis instead of the traditional device level policy definition and enforcement. The proposed invention offers a method and apparatus to define policies per customer and enforce them in the device at the same level. A management interface allows QoS policies to be interactively defined for the compatible network devices.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a block diagram of packet switching network shown as a representative environment for deployment of the present invention.

FIG. 2 is a block diagram showing the management system, management interface and QoS interface of the present invention deployed to work with the network element 102 as referenced in FIG. 1. It shows the breakdown of the management and policy system components. It also highlights the policy enforcement point as a logical component in the overall management system capable of managing a large number of physical and logical devices.

### DETAILED DESCRIPTION OF THE PREFERRED EMBODIMENTS

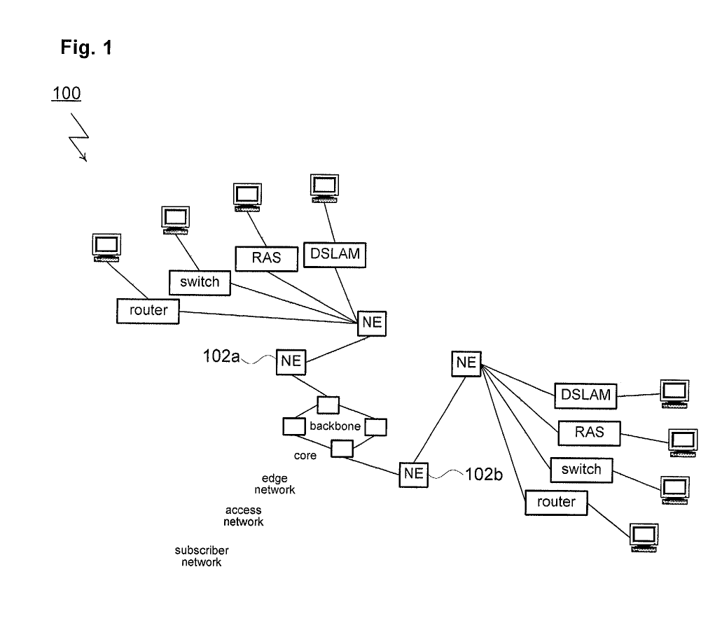

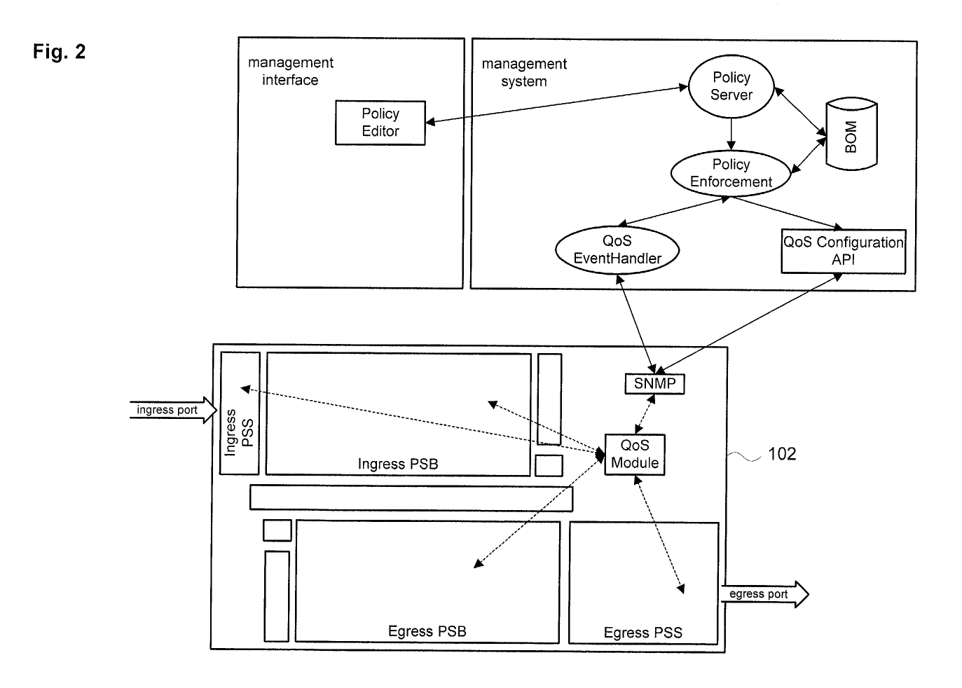

The preferred embodiments of the present invention and their advantages are best understood by referring to FIGS. 1 through 2 of the drawings. Like numerals are used for like and corresponding parts of the various drawings.

The present invention relates to a system (including both method and apparatus) for automatic quality of service (QoS) configuration within packet switching networks. The system is used in combination with one or more compatible network devices.

To be compatible, a network device must support a QoS interface. The QoS interface allows the device to be dynamically configured to apply different QoS configurations to individual microflows. The QoS interface also allows QoS related events for each microflow to be monitored.

The automatic QoS configuration system allows QoS configurations (that define the services allocated to users) to be defined in terms of QoS policies. Each QoS policy is a mapping that defines how the QoS configuration for a microflow changes in response to physical, logical or temporal events.

The automatic QoS configuration system includes a management system. The management system controls (at least partially) one or more of the compatible network devices. The management system monitors the QoS events generated by each compatible network device. Each QoS event involves one or more microflows. In response to these and other events, the management system dynamically reconfigures each compatible network device to enforce the QoS policies for the involved microflows for that device.

The management system includes a policy system, which makes decision on QoS configuration to be enforced at any given time. Policy system includes a management server (policy server) and a policy enforcement point. The primary distinction between the invention proposed here and the policy systems that exist today is that typically the policy enforcement point resides within a device being managed by policy system. With the proposed invention the policy enforcement point is a logical component capable of enforcing policies and QoS configuration on a large number of physical and logical devices. This becomes particularly important for large IP services and aggregation switches where each physical device is a collection of a large number of logical devices.

Another important distinction is the definition and enforcement of policies on a per customer basis instead of the traditional device level policy definition and enforcement. The proposed invention offers a method and apparatus to define policies per customer and enforce them in the device at the same level. A management interface allows QoS policies to be interactively defined for the compatible network devices.

The following sections describe a packet switching network as a representative environment for the automatic QoS configuration system. A network element is then described as a representative compatible network device. The QoS interface is then described followed by a description of QoS policies. The management interface is described last.

In FIG. 1, a packet switching network 100 is shown as a representative environment for the present invention. Network 100 is functionally divided into core, edge, access and subscriber networks. The subscriber network connects end-users to network 100. To accomplish this, the subscriber network provides a series of interfaces (digital subscriber line access multiplexers (DSLAMs), remote access servers, (RASs), switches and routers). Each interface provides network access to a different class of end-users.

The access network includes (or can include) a range of devices that provide remote access to users. These devices may include, for example, dial-up modems or DSL modems for ISP networks, cable modems for cable providers and wireless base stations for wireless network providers. The access network acts as an aggregator; translating the various protocols used by these devices into protocols, such as ATM, that is passed to an Internet service provider.

The edge network aggregates the traffic received from the access networks and passes the aggregated traffic to the core network. Edge network devices are intelligent IP services and aggregation switches where one physical device is a collection of large number of logical devices. These logical devices are allocated to a large number of customers to form their dedicated network. The devices within the edge network process the traffic they receive and forward on a packet-by-packet basis to enforce quality of service (QoS) levels that apply to the traffic.

The core network is functionally furthest from end-users. The core includes the network backbone and is used to provide efficient transport and bandwidth optimization of traffic provided by the edge, access and subscriber networks.

The edge portion of network 100 includes a series of network elements ( 102a, 102b). Each network element 102 is an IP (Internet Protocol) switch. IP switches, like network elements 102 provide network switching or routing at layer three of the OSI network architecture (layer three is also known as the network layer).

Network elements 102 provide differentiated services at the microflow level. This means that network elements 102 apply different QoS configurations to individual microflows. Network elements 102 support multiple user classes. Different users of the system such as device owner, service provider and customers/subscribers define the flow and QoS configurations. For example, device owner and service providers define flow and QoS configurations at an aggregate flow level. Where as subscribers define flows at a very fine grained level there by distributing their traffic as belonging to a certain flow and associating QoS configuration to these fine grained flows. For example, subscribers can define flows on per application, source, destination, etc. and associate QoS configuration to these flows. The following sections use network elements 102 as representative examples of compatible network devices.

FIG. 2 shows the internal details of one possible implementation for network element 102. As shown in FIG. 2, network element 102 includes an ingress port and an egress port. Network element 102 receives ATM cells from network 100 at its ingress port. Network element 102 sends ATM cells back to network 100 using its egress port.

Within network element 102, the received ATM cells received are first passed to the ingress PSS (packet subsystem). Within the ingress PSS the incoming ATM cells are converted into IP packets. An internal header is also added to each IP packet. The internal header is used for routing within network elements 102. The ingress PSS then forwards each IP packet to the ingress PSB (packet services block).

Within the ingress PSB, the IP packets are first processed through a packet classifier. The packet classifier classifies the IP packets received from the ingress PSS as belonging to a particular flow. The packet classifier then forwards packet and flow information to a series of functional units for metering, marking and dropping. Metering, marking and dropping ensure that customer traffic is within agreed upon bounds. This helps to enforce proper QoS across all traffic flowing through the network.

The IP packets that emerge from the ingress PSB are are forwarded through a back plane to an egress PSB.

Within the egress PSB, the DSCP marking in the IP packet is first checked by the QoS component. Depending on the marking in the packets, they are either queued for further processing or are discarded. Algorithms such as RED (Random Early Detection described in U.S. Pat. Ser. No. 6,167,445 “Method and Apparatus for Implementing High Level Quality of Service Policies in Computer Networks”) or variations of RED are used to decide when and which packets to discard.

After processing in egress PSB, the IP packets are forwarded to an egress PSS. Within egress PSS, the IP packets are inserted into one of several queues. The queue selected for each IP packet depends on the QoS level of the packet. The queued packets advance in their queues and are eventually de-queued by the egress PSB. The egress PSB converts the de-queued packets into ATM cells for transmission at the egress port.

Network elements 102 includes an SNMP (Simple Network Management Protocol) interface. External programs use the SNMP interface to monitor and control network element 102.

Each compatible network device is required to provide a QoS interface. The QoS interface allows the device to be dynamically configured to apply different QoS configurations to individual microflows. The QoS interface also allows QoS related events to be monitored. As shown in FIG. 2, network element 102 includes a QoS module to provide the required QoS interface.

The QoS module extends the SNMP interface of network element 102 to allow external programs to perform QoS related monitoring and control. The QoS module does this by providing external access to a set of QoS objects. For the particular implementation of network element 102 as shown in FIG. 2, the QoS objects include the ingress PSS, the ingress PSB, the egress PSB and the egress PSS. Different implementations may have these or different QoS objects.

The QoS objects send QoS related events to the QoS module. The QoS module forwards these events using the SNMP interface. External programs may receive these events. An example of an event of this type might occur when one of the queues in the egress PSS becomes full or empty. Depending on the particular implementation, QoS objects may generate a range of different event types. These include:

QoS object change events. Events of this type occur when a value that is associated with a QoS object reaches a predetermined value. This could be the case, for example, when a queue reaches a predefined length.

Time based events. Events of this type occur when the time (or date) reaches a particular value (e.g., five PM).

SNMP MIB variable event. Events of this type occur when an MIB variable reaches a predefined threshold. For example, the SNMP MIB variable inerrors functions as a counter of packets that have been received with some type of error, such as a bad corrupted packet. An SNMP MIB variable event could be defined to be triggered when inerrors reaches a predefined level within a certain time period (e.g., one thousand errors in one minute).

Microflow. Events of this type relate to particular microflows. As previously mentioned, a microflow is a single instance of an application-to-application flow of packets having a source address, a source port, a destination address, a destination port and a protocol id. A microflow event would be triggered when a microflow is received that matches a predefined combination of one or more of these attributes.

An external management system or a policy system can use these events to evaluate the current QoS configuration to ensure that guaranteed QoS could be delivered to customers. If there are violations then the management system can dynamically update the QoS configuration and download those to the network devices. This can ensure that customer quality of service levels can be met during unanticipated and scheduled traffic pattern changes.

External programs may also use the SNMP interface to pass commands to the QoS module. The QoS module forwards these commands, in turn, to the QoS objects. This allows external programs to control the QoS configuration of network element 102 at the microflow level. The actual data structures used to send configuration commands to the QoS module and QoS object depends largely on the particular implementation. In general, this data structure will include:

1) A subscriber id

2) Conditional criteria, and

3) Action specifications.

The subscriber id identifies the owner of the microflow that is to be reconfigured.

The conditional criteria include information to identify the involved microflow. Typically, this is done using a seven-tuple classifier that includes fields to identify the microflow's source, destination, address, port, subnet mask, application id and ToS (Type of Service). The conditional criteria also include information to identify the particular managed object (QoS object) that is involved in the configuration as well as the threshold values for the condition. The managed object is typically identified by its object id (OID) and the threshold values are typically integer values.

The action specifications describe the QoS configuration parameters that will be changed. This can include, for example, Peak Information Rate (PIR), Committed Information Rate (CIR), Committed Burst Size (CBS) or Exceeded Burst Rate (EBS).

The automatic QoS configuration system allows QoS configurations to be defined in terms of QoS policies. Each QoS policy is a mapping that defines how the QoS configuration for a microflow changes in response to physical, logical or temporal events. Each QoS policy is set of one or more preconditions and one or more actions. As an example, consider the following QoS policy:

POLICY A =
{

Rule 1 {
IF Traffic = SAP
AND
Time = 9am to 5pm
THEN
QOS=GOLD

}
Rule 2 {

IF Traffic = HTTP
AND
Time = 5pm to 8am
OR
Day = Sat
OR
Day=Sun
THEN
QOS=BRONZE

}
Rule 3 {

QOS=SILVER

}

}

This QoS policy has three preconditions. The first applies to SAP (enterprise application software) traffic between the hours of nine and five. The second applies to HTTP traffic that occurs after hours or on weekends. The final precondition is unspecified—meaning that it applies to all traffic without distinction. Each precondition has an action. In each case, the QoS is set to a specified level. The preconditions in a rule are applied in order. Each is tried until a match is found. In this case, the overall effect of the QoS policy is to specify GOLD level service for SAP traffic between the hours of nine and five. After hour and weekend HTTP traffic receives BRONZE service. All other traffic types receive SILVER level service.

The preconditions included in QoS policies may correspond to a wide range of events. These include time based events (e.g., Day=Sun or Time=5 pm to 8 am). Preconditions can also include SNMP traps (SNMP is described in Internet RFCs 1098, 1157, and 1645 among others). QoS preconditions can also include any type of attribute or event that is associated with a QoS object as described with regard to FIG. 2.

The actions included in QoS policies are QoS configurations. Each configuration may be defined using predefined QoS standards such as EF, AF1 . . . BE . . . QoS configurations may also be defined using a range of QoS parameters such as Peak Information Rate (PIR), Committed Information Rate (CIR), Committed Burst Size (CBS), Exceeded Burst Rate (EBS) as well as a range of queuing and policing schemes. For the specific example presented above, the QoS configurations have been defined symbolically as GOLD, SILVER and BRONZE. These symbolic definitions are intended to simplify the choice of QoS configurations for unsophisticated users. The symbolic definitions correspond to some combination of QoS parameters (e.g., PIR, CIR, CBS, EBS) or predefined QoS standards (e.g., EF, AF1 . . . BE).

Each QoS policy is a mapping between preconditions (physical, logical or temporal events) and actions (QoS configurations). Each mapping is potentially dynamic, meaning that the different preconditions will hold at different times.

Network element 102 supports multiple classes of users. Typically, these include device owners, independent service providers and subscribers. Individual microflows may be included in the traffic of one or more users. This happens, for example, when a subscriber purchases a particular microflow from an ISP. In that case, the subscriber's microflow is part of the subscriber's and the ISP's traffic. The ISP may have, in turn, purchased the capacity for the subscriber's microflow from a device owner. In this case, the microflow would be part of the traffic for three users: the device owner, ISP and the subscriber.

The automatic QoS configuration system also includes a management system. The management interface in the management system allows QoS policies to be interactively defined for the compatible network devices. The management system includes one or more processes that execute on an interactive computer system, such as a personal computer or workstation. As shown in FIG. 2, the management system includes a QoS event handler and a QoS configuration API. These two components interact with the QoS Module included in network element 102. The QoS event hander receives QoS events from the QoS module in network element 102. In this way, the QoS events that are generated by the QoS objects in network element 102 reach the management system. The QoS configuration API receives configuration requests generated by the management system. The configuration requests are passed to the QoS module.

The management system also includes a policy enforcement module as shown in FIG. 2. The policy enforcement module is the component in the policy system that actually enforces the policies on the network devices. The policy enforcement module translated policies into actual configuration commands on the network devices.

With existing policy system, the policy enforcement module is in the network devices that translates policy configuration commands into physical device commands. With the proposed invention, the policy enforcement module is in a higher layer entity capable of enforcing policies on a large number of physical and logical network devices. The logical policy enforcement module also allows subscribers to get a view into their private network resources and define policies on those resources. This is in sharp contrast to existing systems where subscriber level logical separation and definition of policies on those resources do not exist.

The logical policy enforcement module described in this invention can expose multiple interfaces such as COPS, IDL, CLI, etc. to the policy server and translate the commands from the policy server to configuration commands on network device(s). Over all the logical policy enforcement module offers a flexible and scalable solution to support policies for a large number of subscribers that can be offered on massively parallel IP services and aggregation switches.

The policy management module functions as a form of state machine. In this role, the policy enforcement module monitors QoS events (generated by the QoS objects and sent via the QoS module and the QoS event handler). The policy enforcement module uses the QoS policies to map QoS events into QoS configurations. The policy enforcement module uses the QoS module to download these QoS configuration to the QoS objects (using the QoS configuration API and QoS Module). The event-to-configuration mappings applied by the policy enforcement module enforce the QoS policies that apply to the network element 102.

The management system also includes a policy server and a BOM. The BOM is a persistent storage system that stores QoS policies. For most implementations, the BOM is implemented as a database. It should be appreciated, however, that any methodology that provides fault-tolerant storage for QoS policies may be used. The policy server forwards QoS policies to the policy enforcement module for enforcement.

The automatic QoS configuration system also includes a management interface. The management interface allows QoS policies to be interactively defined for the compatible network devices. The management interface includes one or more processes that execute on an interactive computer system, such as a personal computer or workstation.

What is claimed is:

1. A method for managing a communications network, the method comprising the steps of:
Selecting a microflow within the communications network;
Defining a QoS configuration;
Defining an event; and
Creating a QoS policy requiring application of the QoS configuration to the microflow upon occurrence of the event.

2. A method as recited in claim 1 further comprising the step of specifying a symbolic name for the QoS policy.

3. A method as recited in claim 1 wherein the QoS configuration is defined using one or more of the following: Peak Information Rate (PIR), Committed Information Rate (CIR), Committed Burst Size (CBS) or Exceeded Burst Rate (EBS).

4. A method as recited in claim 1 wherein the QoS configuration is defined using a predefined QoS standard such as EF, AF1 or BE.

5. A method as recited in claim 1 wherein the event is one of the following: QoS object change event, time-based event, SNMP MIB variable event, or microflow event.

6. A method as recited in claim 1 further comprising the steps of:
Transmitting information from a management system to a network device to the cause the network device to detect occurrence of the event; and
Transmitting information from the network device to the management system when the event is detected.

7. A method as recited in claim 4 further comprising the step of transmitting information from the management server to cause the network device to apply the QoS configuration to the microflow.

8. A method as recited in claims 6 or 7 wherein the network device and the management system communicate using SNMP.

9. A management system for a communications network, the management system comprising:
A persistent storage system for storing a QoS policy, the QoS policy associated with a microflow in the communications network, the QoS policy including a QoS configuration and a corresponding event;
An event handler configured to allow the management system to receive notification from a network device of occurrence of the event; and
A management interface configured to allow the management system to cause the network device to apply the QoS configuration to the microflow.

10. A system as recited in claim 9 wherein the management interface is configured to allow the management system to cause the network device to detect the event.

11. A system as recited in claim 9 that performs dynamic configuration of the network devices to meet the customer quality of service level guarantees depending on the detection of QoS related events.

12. A system as recited in claim 9 where in the management interface is configured to allow the customers/subscribers to define policies on their logical resources, which is then verified and enforced by the management system.

13. A system as recited in claim 9 where in there is a logical policy enforcement point capable of exposing multiple communication interfaces to the policy server and also capable of managing a large number of physical and logical devices offering a flexible and scalable solution to support policies for a large number of subscribers that can be offered on massively parallel IP services and aggregation switches.

14. A system as recited in claim 9 wherein the QoS configuration is defined using one or more of the following: Peak Information Rate (PIR), Committed Information Rate (CIR), Committed Burst Size (CBS) or Exceeded Burst Rate (EBS).

15. A system as recited in claim 9 wherein the QoS configuration is defined using a predefined QoS standard such as EF, AF1 or BE.

16. A system as recited in claim 9 wherein the event is one of the following: QoS object change event, time-based event, SNMP MIB variable event, or microflow event.

17. A system as recited in claim 9 wherein the network device and the management system communicate using SNMP.

18. A QoS module for use with a network device in a communications network, the QoS module configured to:
Allow a management system to configure the network device to detect an event associated with a microflow; and
Notify the network device upon occurrence of the event.

19. A QoS module as recited in claim 15 wherein the QoS module is configured to allow the management system to configure the network device to apply a QoS configuration to the microflow.

20. A QoS module as recited in claim 15 wherein the event is one of the following: QoS object change event, time-based event, SNMP MIB variable event, or microflow event.

21. A QoS module as recited in claim 16 wherein the QoS configuration is specified using one or more of the following: Peak Information Rate (PIR), Committed Information Rate (CIR), Committed Burst Size (CBS) or Exceeded Burst Rate (EBS).

22. A QoS module as recited in claim 16 wherein the QoS configuration is specified using a predefined QoS standard such as EF, AF1 or BE.

23. A QoS module as recited in claim 15 wherein the QoS module and the management system communicate using SNMP.
